(19) United States
(12) Patent Application Publication
(10) Pub. No.: US 2026/0202925 A1
(43) Pub. Date: Jul. 16, 2026

(54) ELECTRONIC DEVICE CONTROL METHOD, ELECTRONIC DEVICE, AND STORAGE MEDIUM

(71) Applicant: Lenovo (Beijing) Limited, Beijing (CN)

(72) Inventors: Xiaofeng ZHU, Beijing (CN); Sanjay DHAR, Chicago, IL (US)

(21) Appl. No.: 19/438,120

(22) Filed: Dec. 31, 2025

(30) Foreign Application Priority Data
Jan. 10, 2025 (CN) 202510046105.9

(51) Int. Cl. G06F 3/038; G06F 3/0354; G06F 3/041

(52) U.S. Cl. CPC G06F 3/038; G06F 3/03545; G06F 3/0416; G06F 2203/04102

(57) ABSTRACT

An electronic device control method, an electronic device, and a storage medium are provided in the present disclosure. The control method includes determining whether a second device is in a target region based on position information of the second device; in response to a determination that the second device is in the target region, determining a target operation at least based on the position information of the second device; and executing the target operation, wherein the target operation is configured to control an electronic device to change attitude.

### CROSS-REFERENCE TO RELATED APPLICATION

This application claims priority to Chinese Application No. 202510046105.9, filed on Jan. 10, 2025, the entire content of which is incorporated herein by reference.

### TECHNICAL FIELD

The present disclosure generally relates to the field of data processing technology, and, more particularly, relates to an electronic device control method, an electronic device, and a storage medium.

### BACKGROUND

For electronic devices with scrollable or retractable screens, currently, users may only control the screens of the electronic devices to scroll or retract by pressing physical buttons or performing preset gestures on the screens of the electronic devices. The control of such type of electronic devices may be not sufficiently intelligent, which may affect user experience.

### SUMMARY

One aspect of the present disclosure provides an electronic device control method. The method includes determining whether a second device is in a target region based on position information of the second device; in response to a determination that the second device is in the target region, determining a target operation at least based on the position information of the second device; and executing the target operation, wherein the target operation is configured to control an electronic device to change attitude.

Another aspect of the present disclosure provides an electronic device. The electronic device includes a signal obtaining module, configured to obtain position information of a second device; a deformable display apparatus, wherein a region of the deformable display apparatus for display output includes a deformable region; the deformable region has a first orientation and a second orientation; the first orientation is different from the second orientation; the deformable display apparatus switches between a first attitude and a second attitude; and an area of the deformable region is capable of being changed relative to the region of the deformable display apparatus for display output. The electronic device further includes a housing; a power apparatus, configured to drive the display apparatus to move relative to the housing; and a processor, configured to determine whether the second device is in a target region based on the position information of the second device; in response to a determination that the second device is in the target region, determine a target operation at least based on the position information of the second device; and control the power apparatus to drive the display apparatus to execute the target operation, wherein the target operation is configured to control the electronic device to change attitude.

Another aspect of the present disclosure provides a non-transitory computer-readable storage medium, containing a computer program for when executed by a processor, performing an electronic device control method. The method includes determining whether a second device is in a target region based on position information of the second device; in response to a determination that the second device is in the target region, determining a target operation at least based on the position information of the second device; and executing the target operation, wherein the target operation is configured to control an electronic device to change attitude.

Other aspects of the present disclosure may be understood by those skilled in the art in light of the description, the claims, and the drawings of the present disclosure.

### BRIEF DESCRIPTION OF THE DRAWINGS

Above-mentioned and other objectives, features and advantages of exemplary embodiments of the present disclosure are readily understood by reading following detailed description with reference to the accompanying drawings. In accompanying drawings, a plurality of embodiments of the present disclosure are exemplarily illustrated, which may not limit the present disclosure. In the drawings, same or corresponding reference numerals denote same or corresponding parts.

FIG. 1 illustrates a flowchart of an electronic device control method according to various embodiments of the present disclosure.

FIG. 2A illustrates a schematic of an electronic device according to various embodiments of the present disclosure.

FIG. 2B illustrates another schematic of an electronic device according to various embodiments of the present disclosure.

FIG. 2C illustrates another schematic of an electronic device according to various embodiments of the present disclosure.

FIG. 3A illustrates another schematic of an electronic device according to various embodiments of the present disclosure.

FIG. 3B illustrates another schematic of an electronic device according to various embodiments of the present disclosure.

FIG. 3C illustrates another schematic of an electronic device according to various embodiments of the present disclosure.

FIG. 4A illustrates another schematic of an electronic device according to various embodiments of the present disclosure.

FIG. 4B illustrates another schematic of an electronic device according to various embodiments of the present disclosure.

FIG. 5 illustrates another schematic of an electronic device according to various embodiments of the present disclosure.

FIG. 6A illustrates another schematic of an electronic device according to various embodiments of the present disclosure.

FIG. 6B illustrates another schematic of an electronic device according to various embodiments of the present disclosure.

FIG. 7 illustrates another flowchart of an electronic device control method according to various embodiments of the present disclosure.

FIG. 8 illustrates another schematic of an electronic device according to various embodiments of the present disclosure.

FIG. 9A illustrates another schematic of an electronic device according to various embodiments of the present disclosure.

FIG. 9B illustrates another schematic of an electronic device according to various embodiments of the present disclosure.

FIG. 10 illustrates another flowchart of an electronic device control method according to various embodiments of the present disclosure.

FIG. 11A illustrates another schematic of an electronic device according to various embodiments of the present disclosure.

FIG. 11B illustrates another schematic of an electronic device according to various embodiments of the present disclosure.

FIG. 12A illustrates another schematic of an electronic device according to various embodiments of the present disclosure.

FIG. 12B illustrates another schematic of an electronic device according to various embodiments of the present disclosure.

FIG. 13 illustrates another flowchart of an electronic device control method according to various embodiments of the present disclosure.

FIG. 14A illustrates another schematic of an electronic device according to various embodiments of the present disclosure.

FIG. 14B illustrates another schematic of an electronic device according to various embodiments of the present disclosure.

FIG. 15 illustrates another flowchart of an electronic device control method according to various embodiments of the present disclosure.

FIG. 16A illustrates another schematic of an electronic device according to various embodiments of the present disclosure.

FIG. 16B illustrates another schematic of an electronic device according to various embodiments of the present disclosure.

FIG. 16C illustrates another schematic of an electronic device according to various embodiments of the present disclosure.

FIG. 16D illustrates another schematic of an electronic device according to various embodiments of the present disclosure.

FIG. 17 illustrates another flowchart of an electronic device control method according to various embodiments of the present disclosure.

FIG. 18A illustrates another schematic of an electronic device according to various embodiments of the present disclosure.

FIG. 18B illustrates another schematic of an electronic device according to various embodiments of the present disclosure.

FIG. 19 illustrates a compositional structural schematic of an electronic device according to various embodiments of the present disclosure.

FIG. 20 illustrates a structural schematic of an electronic device control apparatus according to various embodiments of the present disclosure.

### DETAILED DESCRIPTION

The technical solutions in embodiments of the present disclosure are clearly and completely described below with reference to the accompanying drawings in embodiments of the present disclosure. Obviously, described embodiments are only a part of embodiments of the present disclosure, but not all embodiments. Based on embodiments in the present disclosure, all other embodiments obtained by those skilled in the art without creative efforts shall fall within the protection scope of the present disclosure.

In order to intelligently control electronic devices and improve the user experience, an electronic device control method is provided in embodiments of the present disclosure. As shown in FIG. 1, the control method may include following exemplary steps.

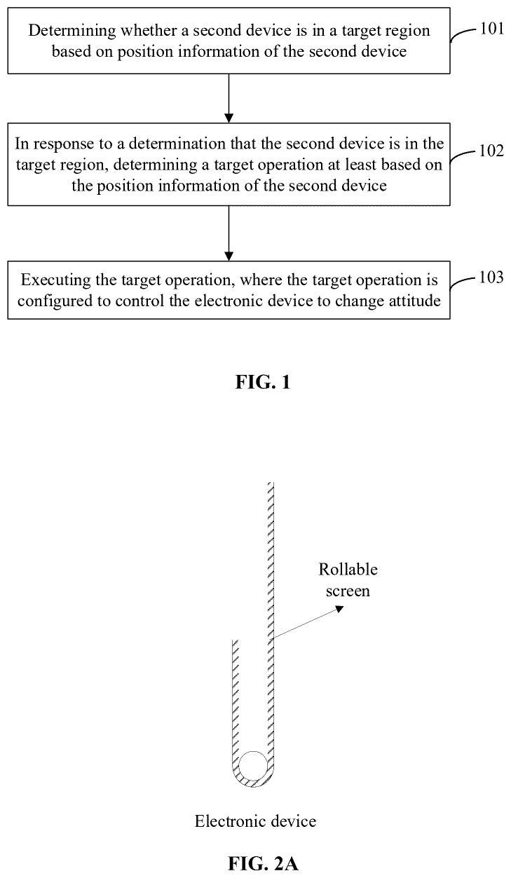

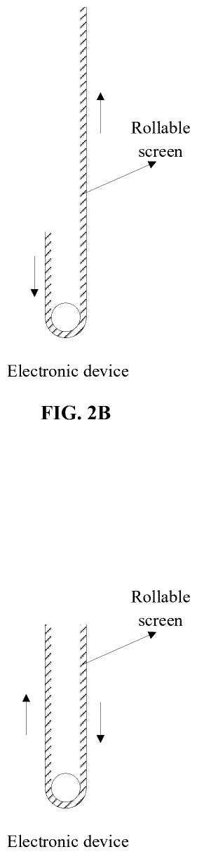

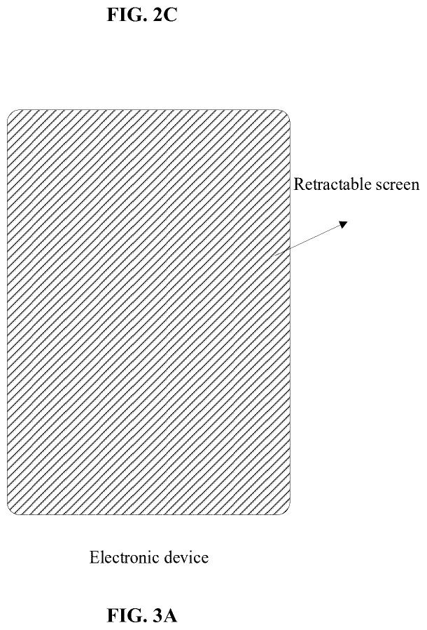

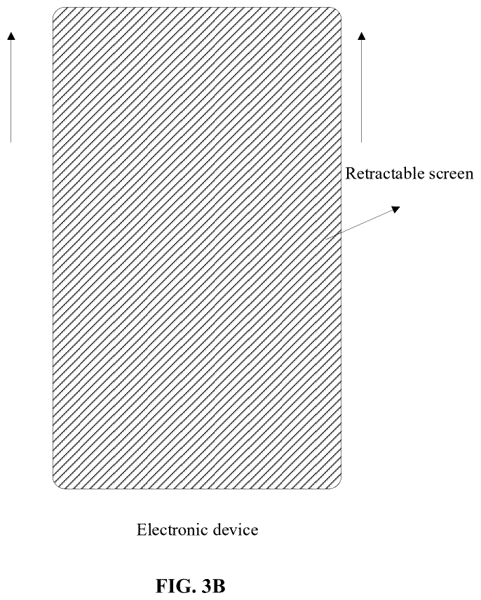

In one embodiment, the electronic device controlled may be an electronic device with a rollable screen as shown in FIG. 2A. The rollable screen may be made of a flexible material which may be bent to form the rollable screen as shown in FIG. 2A; and the screen may be expanded or contracted by control. The electronic device in FIG. 2A may control the rollable screen to expand to the form shown in FIG. 2B. The electronic device in FIG. 2A may also control the rollable screen to contract to the form shown in FIG. 2C.

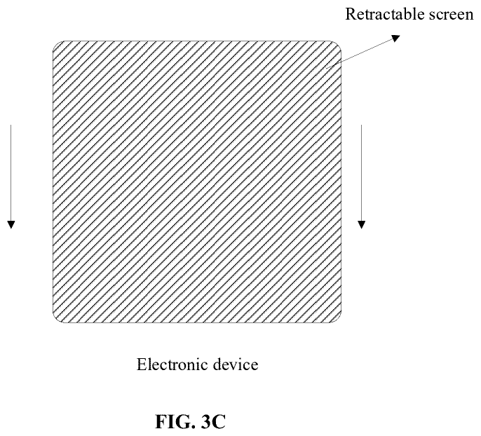

In one embodiment, the electronic device may also be the electronic device with a retractable screen as shown in FIG. 3A. The retractable screen may be made of a retractable material and controlled to expand or contract the screen in all directions. The electronic device in FIG. 3A may control the retractable screen to expand to the form shown in FIG. 3B. The electronic device in FIG. 3A may also control the retractable screen to contract to the form shown in FIG. 3C.

At 101, whether the second device is in the target region may be determined based on the position information of the second device.

In one embodiment, the second device may be a stylus, a touch-control glove or other devices.

In one embodiment, the position information may include the spatial position of the second device, the contact position and the pressure position when the second device and the electronic device perform touch screen operations.

The electronic device may establish connection with the second device through technologies such as UWB (ultra-wideband technology), Bluetooth, Wi-Fi and/or the like. After the connection is established, the electronic device may obtain the spatial position of the second device in real time through the connection. The electronic device may obtain information such as the contact position, the pressure position and the pressure magnitude when the second device and the electronic device perform touch screen operations through a pressure sensor.

At 102, in response to the determination that the second device is in the target region, a target operation may be determined at least based on the position information.

The target region may be a region where the electronic device may receive the position information of the second device. In response to the determination that the second device is in the target region, the target operation may be determined based on the position information.

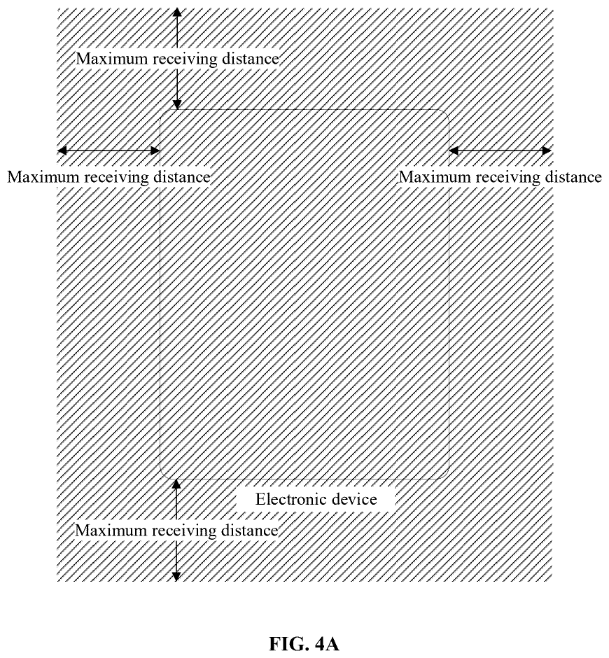

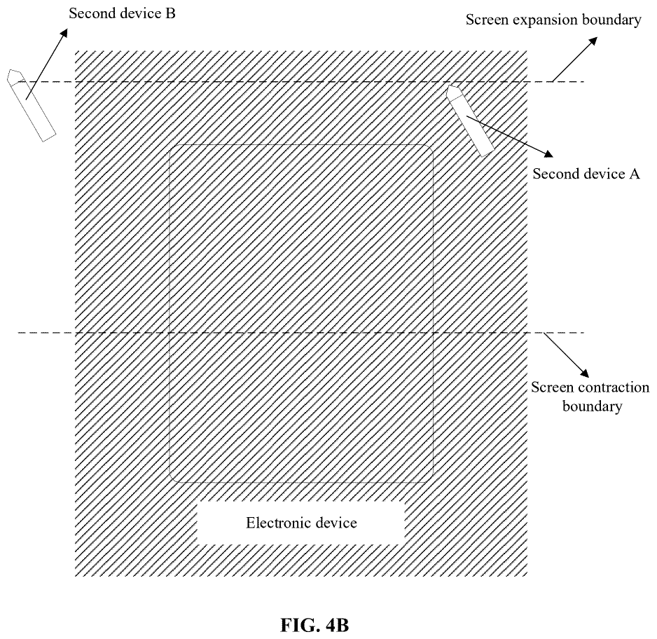

For example, as shown in FIG. 4A, the target region shown in FIG. 4A may be the shaded portion, which may be the region formed by the maximum receiving distances that may receive the position information of the second device at the left, right, top and bottom of the electronic device.

For another example, as shown in FIG. 4B, the target region in FIG. 4B may be the shaded portion, which may be also the region formed by the maximum receiving distances that may receive the position information of the second device at the left, right, top and bottom of the electronic device. The second device A may be in the target region. The second device A may be in the region within the upper screen expansion boundary (i.e., the maximum position that the screen of the electronic device may expand). Therefore, the spatial position of the second device A may be determined based on the position information of the second device A, and then the screen of the electronic device may expand to the spatial position where the second device A is located. The second device B may not be in the target region, such that no processing may be performed. It should be noted that in response to that the second device is within the maximum receiving distance above the electronic device but exceeds the screen expansion boundary, the screen of the electronic device may be controlled to expand to the screen expansion boundary. Similarly, in response to that the second device is within the maximum receiving distance below the electronic device but exceeds the screen contraction boundary (i.e., the minimum position that the screen of the electronic device may contract), the screen of the electronic device may be controlled to contract to the screen contraction boundary.

In one embodiment, the spatial position of the second device may be determined based on the coordinate system established by the electronic device, and the electronic device may establish the coordinate system with the lower left corner of the electronic device as the origin. The spatial position of the second device may be determined based on the coordinates of the second device in the coordinate system. In other embodiments, any other method capable of determining the spatial position of the second device may also be used.

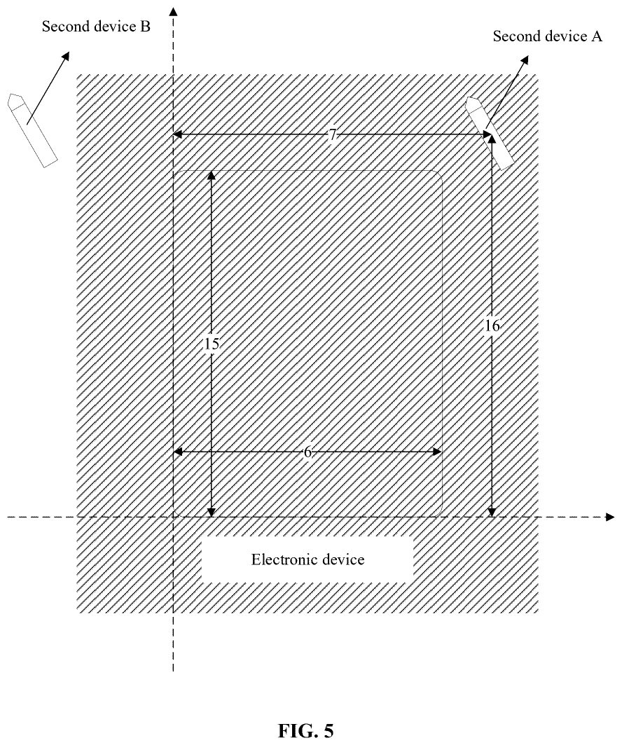

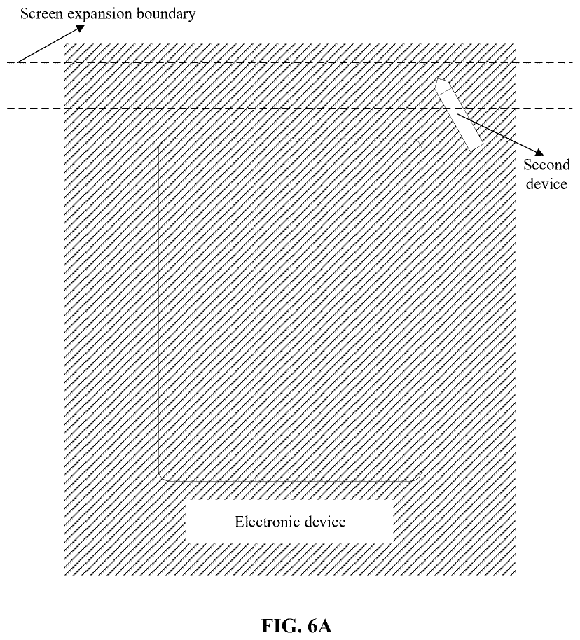

For example, as shown in FIG. 5, the target region in FIG. 5 may be the shaded portion, which may be also the region formed by the maximum receiving distances that may receive the position information of the second device at the left, right, top and bottom of the electronic device. The electronic device may be 6 cm wide and 15 cm high. The coordinate system may be established with the lower left corner of the electronic device as the origin. Therefore, the position of the second device A in the coordinate system may be (7, 16). Based on above-mentioned data, the spatial position of the second device A may be determined to be 1 cm to the right and 1 cm above the electronic device. The second device B may be not in the target region and exceed the maximum receiving distance of the electronic device. Therefore, the spatial position of the second device B cannot be determined.

It should be noted that it may also configure that the target operation may be determined based on the position information of the second device in response to determination that the second device is in the target region for more than a preset time or determination that the trajectory formed by the movement of the second device in the target region conforms to the trajectory of a preset gesture.

At 103, the target operation may be executed, and the target operation may be configured to control the electronic device to change attitude.

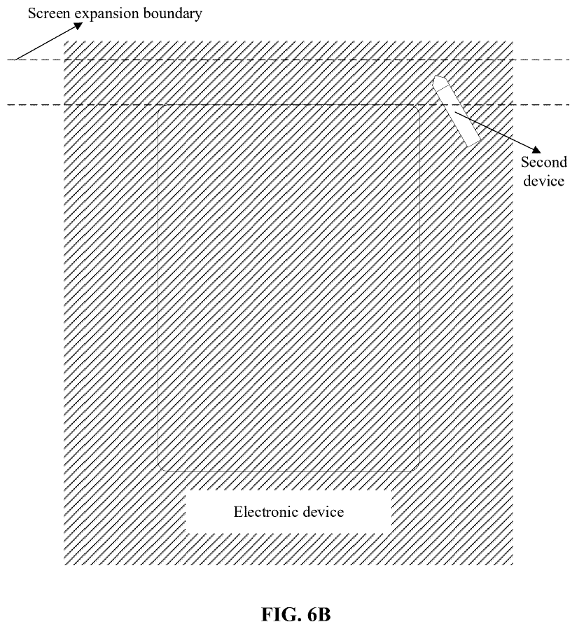

For example, as shown in FIG. 6A, the electronic device may detect that the second device is in the target region; the position information of the second device may be obtained; and based on the position information, it may determine that the spatial position of the second device is at the position shown by the dotted line in FIG. 6A and within the screen expansion boundary of the electronic device. Therefore, it may determine that the target operation may be to expand the screen of the electronic device to the spatial position where the second device is located. As shown in FIG. 6B, the screen of the electronic device may expand to the spatial position where the second device is located.

In above-mentioned solution, whether the second device is in the target region may be determined by obtaining the position information of the second device; in response to that the second device is in the target region, the target operation may be performed to change the attitude of the electronic device, which may realize intelligent control of the electronic device and significantly improve the user experience.

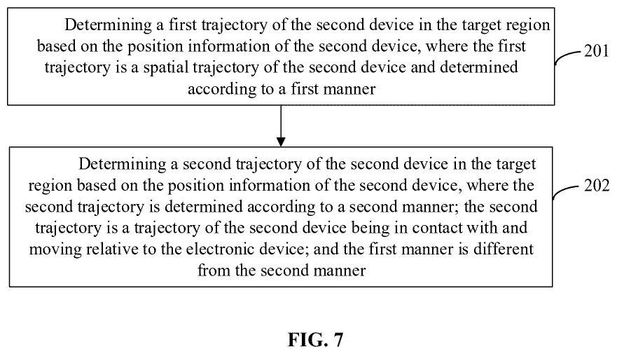

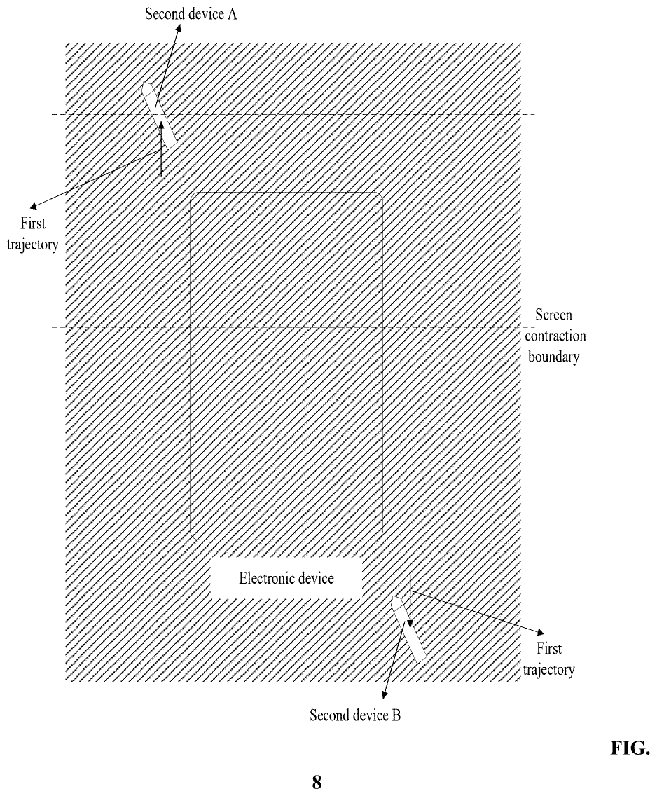

An electronic device control method is also provided in one embodiment pf the present disclosure. As shown in FIG. 7, the control method may further include following exemplary steps.

At 201, based on the position information of the second device, the first trajectory of the second device in the target region may be determined. The first trajectory may be determined according to the first manner. The first trajectory may be the spatial trajectory of the second device.

In one embodiment, the first manner may be obtaining the spatial position of the second device through the position information of the second device and determining the first trajectory of the second device in the target region based on the spatial position of the second device.

The first trajectory may be completed when the second device is not in contact with the electronic device (that is, the second device does not touch the screen of the electronic device).

At 202, based on the position information of the second device, the second trajectory of the second device in the target region may be determined. The second trajectory may be determined according to the second manner. The second trajectory may be the trajectory of the second device being in contact with the electronic device and moving relative to the electronic device. The first manner may be different from the second manner.

In one embodiment, the second manner may be obtaining the pressure information between the second device and the screen of the electronic device through the position information of the second device and determining the second trajectory of the second device in the target region based on the pressure information between the second device and the screen of the electronic device.

The second trajectory may be completed when the second device is in contact with the electronic device (i.e., the second device touches the screen of the electronic device).

The target operation may be determined based on the position information in response to a satisfaction of at least one of the following conditions: determining that the first trajectory is a preset trajectory and determining that the second trajectory is a preset trajectory.

In response to that the first trajectory is the preset trajectory, the second trajectory is the preset trajectory, or both the first trajectory and the second trajectory are the preset trajectory, the target operation may be determined based on the position information.

It should be pointed out that the target operation may be determined based on the position information also in response to that the third trajectory formed by combining the first trajectory and the second trajectory is the preset trajectory. The preset trajectory corresponding to the first trajectory, the preset trajectory corresponding to the second trajectory, and the preset trajectory corresponding to the third trajectory may all be same or different. In addition, there may be multiple preset trajectories corresponding to the first trajectory, multiple preset trajectories corresponding to the second trajectory, and multiple preset trajectories corresponding to the third trajectory; and different preset trajectories may correspond to different target operations.

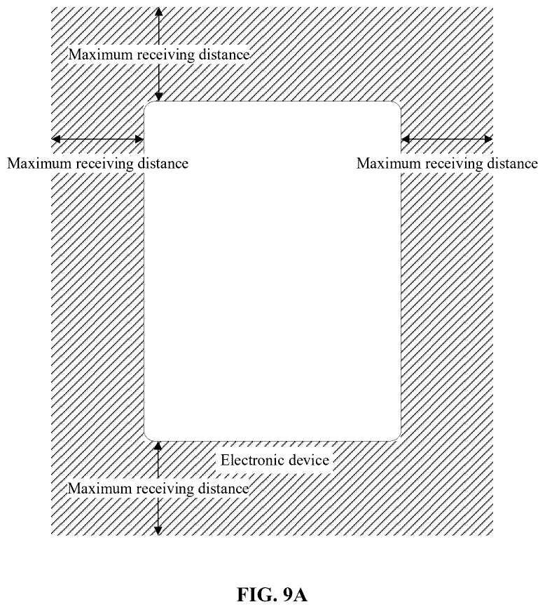

For example, as shown in FIG. 8, the shaded portion in FIG. 8 may be the target region; and the preset trajectories corresponding to the first trajectory may be two, that is, a straight line in an upward direction and a straight line in a downward direction. The first trajectory of the second device A may be determined to be the straight line in the upward direction, such that the target operation may be determined to expand the screen of the electronic device to the spatial position where the second device is located (i.e., the upper dotted line position in FIG. 8). The first trajectory of the second device B may be determined to be the straight line in the downward direction, and the spatial position of the second device B after movement may be below the screen contraction boundary, such that the target operation may be determined to contract the screen of the electronic device to the screen contraction boundary position (i.e., the lower dotted line position in FIG. 8).

In above-mentioned solution, by setting the preset trajectory, when determining that the first trajectory of the second device is the preset trajectory, the second trajectory is the preset trajectory, or both the first trajectory and the second trajectory are the preset trajectory, the target operation may be determined based on the position information of the second device, which may effectively prevent the screen of the electronic device from being moved incorrectly when the second device is detected incorrectly and further improving the intelligence of controlling the electronic device.

An electronic device control method is also provided in one embodiment of the present disclosure. Determining whether the second device is in the target region based on the position information of the second device may include that, in response to determination that the second device is at least in the first region based on the position information, determining that a determination result may characterize the second device to be in the target region. The first region may not include the display region of the electronic device.

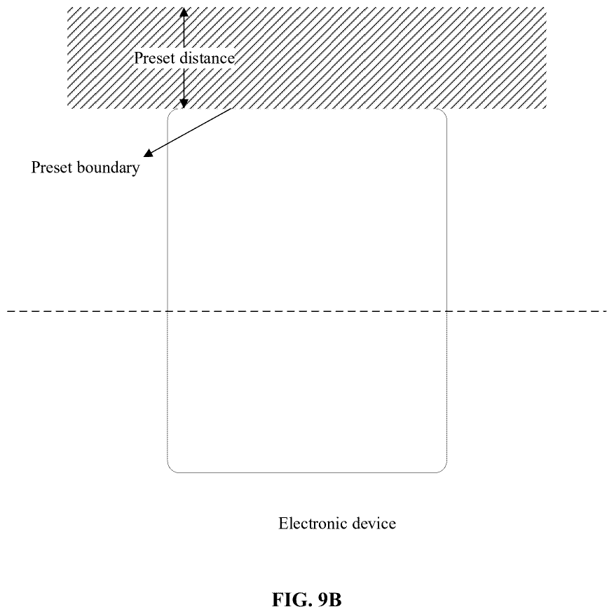

As shown in FIG. 9A, the shaded portion in FIG. 9A may be the first region, which may be the region formed by the maximum receiving distances that may receive the position information of the second device at the left, right, top and bottom of the electronic device. The first region may not include the display region of the electronic device.

In one embodiment, the second device may not be in contact with the screen of the electronic device, such that the position information of the second device may be obtained by receiving the signal of the second device through the connection established with the second device.

In above-mentioned solution, the position information of the second device may be obtained by receiving the signal of the second device through the connection established with the second device, and it may determine that the second device is in the first region based on the position information. Therefore, the second device may be determined to be in the target region, and corresponding target operation may be determined based on the position information, which may further improve the intelligence of controlling the electronic device.

An electronic device control method is also provided in one embodiment of the present disclosure. Determining whether the second device is in the target region based on the position information of the second device may include that, in response to determination that the second device is at least in the display region of the electronic device based on the position information, determining that the determination result may characterize the second device to be in the target region.

As shown in FIG. 9B, the rectangular region in FIG. 9B may be the display region of the electronic device. In FIG. 9B, the shaded portion illustrates a preset distance, which may be the farthest distance that the electronic device may expand to, and the preset boundary may be the boundary of the electronic device without expansion. The display region of the electronic device may change along with the expansion or contraction of the electronic device.

In one embodiment, when the second device is in contact with the screen of the electronic device, the position information of the second device may be obtained through a touch screen signal of the second device on the electronic device.

In above-mentioned solution, the position information of the second device may be obtained through the touch screen signal of the second device on the electronic device, and it may determine that the second device is in the display region of the electronic device based on the position information. Therefore, the second device may be determined to be in the target region, and corresponding target operation may be determined based on the position information, which may further improve the intelligence of controlling the electronic device.

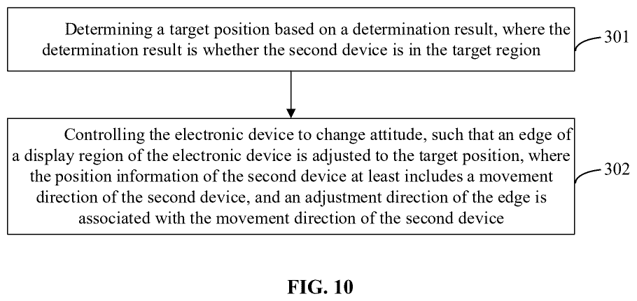

An electronic device control method is also provided in one embodiment of the present disclosure. As shown in FIG. 10, executing the target operation may include following exemplary steps.

At 301, the target position may be determined based on the determination result, and the determination result may be whether the second device is in the target region.

In response to that the second device is in the first region, the target position of the second device may be determined by the spatial position of the second device.

In one embodiment, the spatial position of the second device may be determined based on the coordinate system established by the electronic device, and the electronic device may establish the coordinate system with the lower left corner of the electronic device as the origin. The spatial position of the second device may be determined based on the coordinates of the second device in the coordinate system. In other embodiments, any other method capable of determining the spatial position of the second device may also be used.

For example, as shown in FIG. 5, the target region in FIG. 5 may be the shaded portion, which may be also the region formed by the maximum receiving distances that may receive the position information of the second device at the left, right, top and bottom of the electronic device. The electronic device may be 6 cm wide and 15 cm high. The coordinate system may be established with the lower left corner of the electronic device as the origin. The position of the second device A in the coordinate system may be (7, 16). Based on above-mentioned data, the spatial position of the second device A may be determined to be 1 cm to the right and 1 cm above the electronic device. However, the second device B may be in the target region, which may exceed the maximum receiving distance of the electronic device. Therefore, the spatial position of the second device B cannot be determined.

In response to that the second device is in the display region of the electronic device, since the second device is in contact with the screen of the electronic device, the target position of the second device may be directly obtained through the touch screen signal of the second device on the screen of the electronic device.

At 302, the electronic device may be controlled to change attitude, such that the edge of the display region of the electronic device may be adjusted to the target position, where the position information may at least include the movement direction of the second device, and the adjustment direction of the edge may be related to the movement direction of the second device.

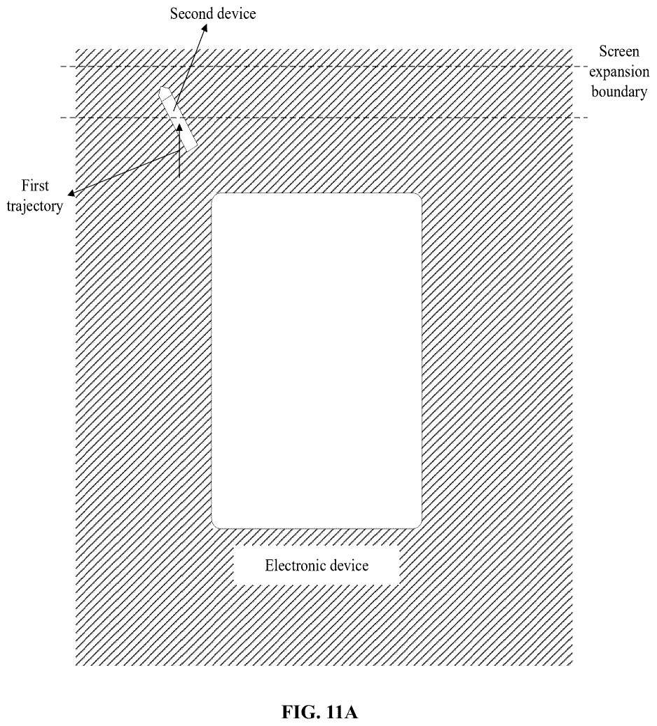

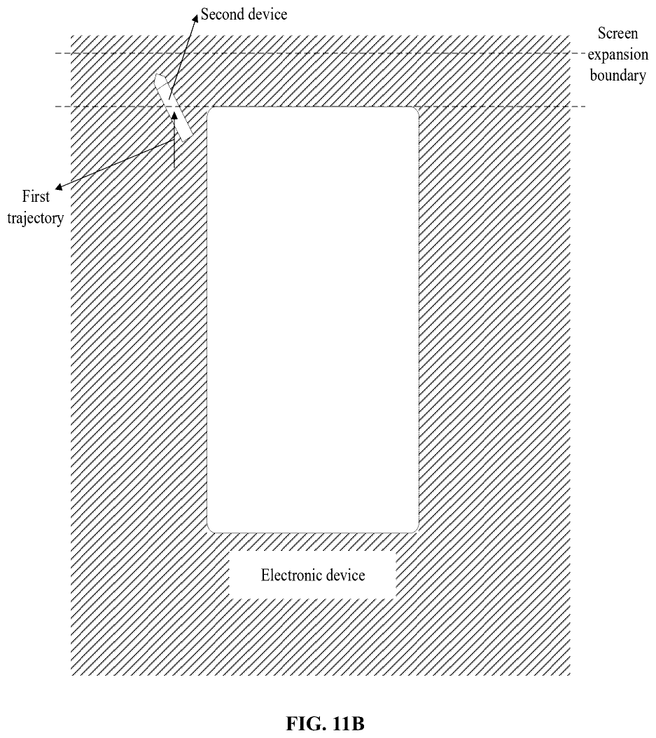

For example, as shown in FIG. 11A, the shaded portion in FIG. 11A may be the first region. Based on the spatial position of the second device, the target position of the second device may be determined to be the position shown in FIG. 11A, which may not exceed the screen expansion boundary; and the second device may move to the target position through the first trajectory shown in FIG. 11A (the movement direction is upward). Therefore, as shown in FIG. 11B, the screen of the electronic device may expand to the spatial position where the second device is located.

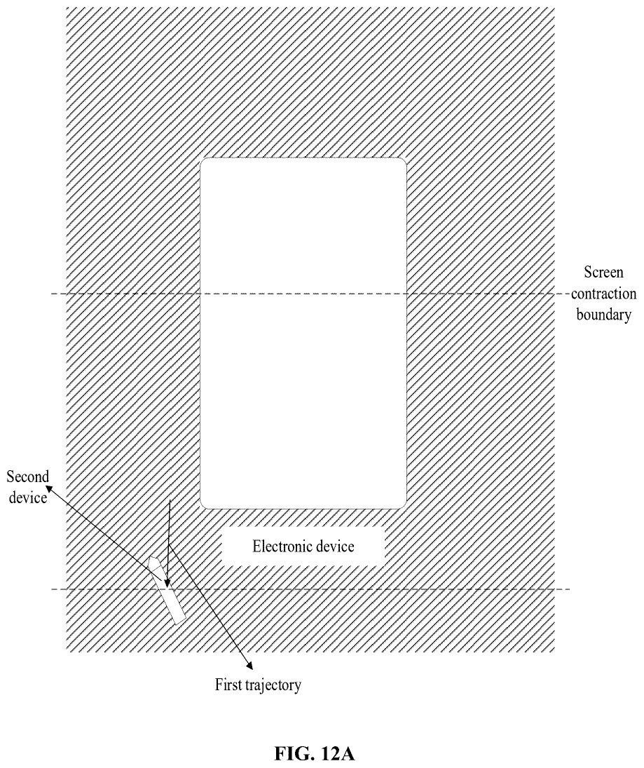

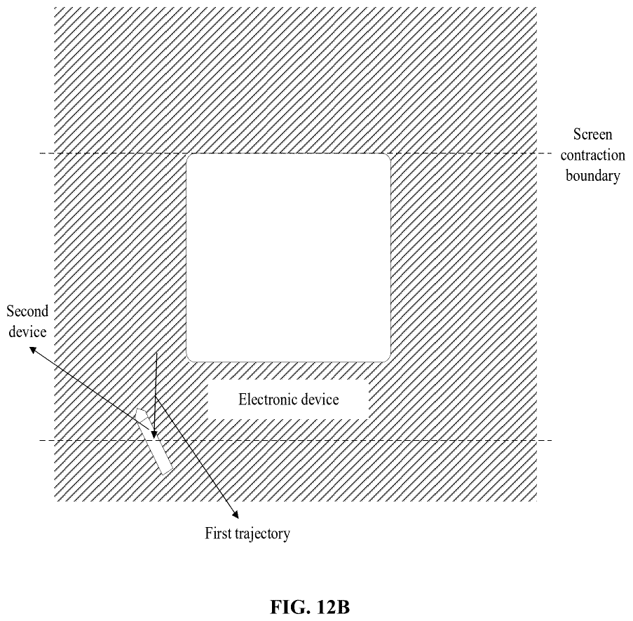

For another example, as shown in FIG. 12A, the shaded portion in FIG. 12A may be the first region. Based on the spatial position of the second device, the target position of the second device may be determined to be the position shown in FIG. 12A, which may exceed the screen contraction boundary; and the second device may move to the target position through the first trajectory shown in FIG. 12A (the movement direction is downward). Therefore, as shown in FIG. 12B, the screen of the electronic device is contracted to the screen contraction boundary.

In above-mentioned solution, the target position of the second device may be determined based on the determination result. Next, the electronic device may be controlled to adjust the edge of the display region to the target position based on the movement direction of the second device. The expansion and contraction of the electronic device may be intelligently controlled by the movement direction of the second device, thereby further improving the user experience.

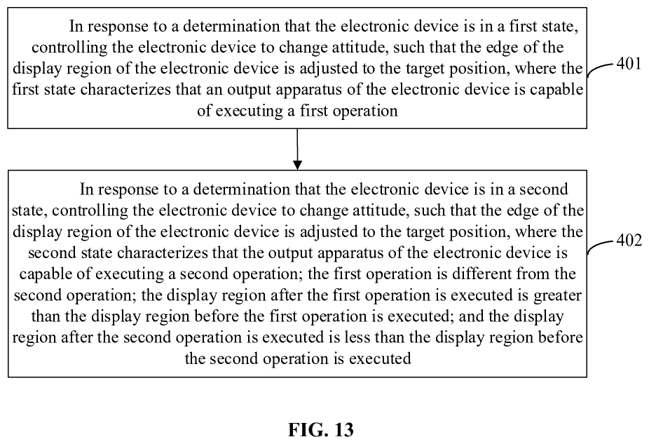

An electronic device control method is also provided in one embodiment of the present disclosure. As shown in FIG. 13, the control method may include following exemplary steps.

At 401, in response to determination that the electronic device is in the first state, the electronic device may be controlled to change attitude, such that the edge of the display region of the electronic device may be adjusted to the target position. The first state may characterize that the output apparatus of the electronic device may perform the first operation.

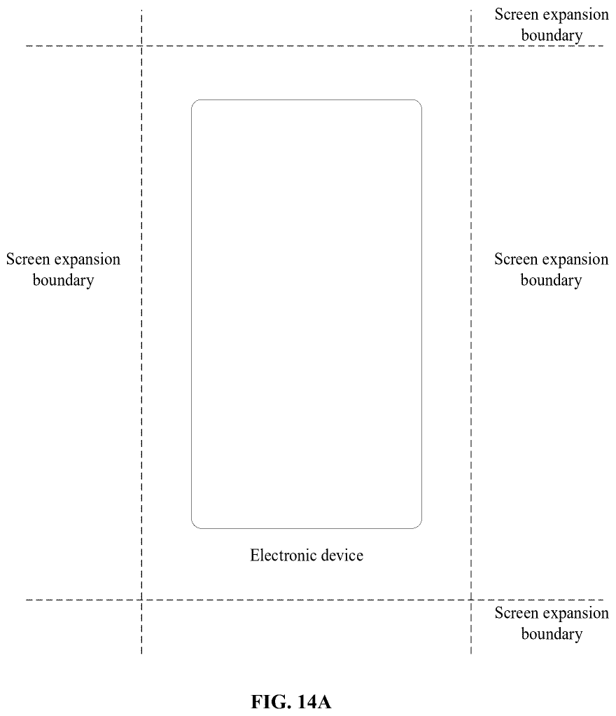

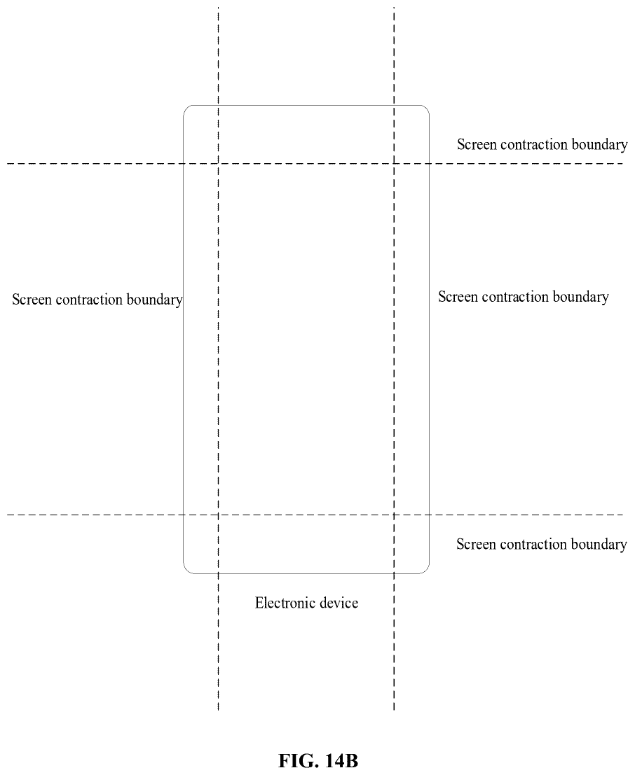

For example, as shown in FIG. 14A, the edge of the display region of the electronic device in the first state may be not adjusted to the screen expansion boundary (the dotted line in FIG. 14A). At this point, the electronic device may be controlled to perform the first operation to adjust the edge of the display region of the electronic device to the target position of the second device.

At 402, in response to determination that the electronic device is in the second state, the electronic device may be controlled to change attitude, such that the edge of the display region of the electronic device may be adjusted to the target position. The second state may characterize that the output apparatus of the electronic device may perform the second operation. The first operation may be different from the second operation. The display region after performing the first operation may be greater than the display region before performing the first operation; and the display region after performing the second operation may be smaller than the display region before performing the second operation.

For example, as shown in FIG. 14B, the edge of the display region of the electronic device in the second state may be not adjusted to the screen contraction boundary (the dashed line in FIG. 14B). At this point, the electronic device may be controlled to perform the second operation to adjust the edge of the display region of the electronic device to the target position of the second device.

It should be noted that the screen expansion boundary and screen contraction boundary of the electronic device may be not on all four sides or only on one side, which may be determined based on the function of the electronic device.

In above-mentioned solution, boundaries may exist when the electronic device performs the operation of expansion or contraction. Therefore, when the electronic device is determined to be in the first state, the electronic device may be controlled to perform the first operation to adjust the edge of the display region of the electronic device to the target position of the second device. When the electronic device is determined to be in the second state, the electronic device may be controlled to perform the second operation to adjust the edge of the display region of the electronic device to the target position of the second device. In such way, the electronic device may be prevented from being damaged by the output apparatus continuing to operate when the electronic device cannot perform the first operation or the second operation, whereby improving the stability and usability of the electronic device control method.

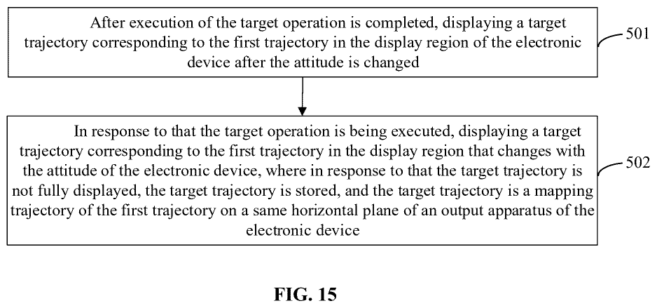

An electronic device control method is also provided in one embodiment of the present disclosure. As shown in FIG. 15, the control method may at least further include one of the following exemplary steps.

At 501, after the target operation is completed, the target trajectory corresponding to the first trajectory may be displayed in the display region of the electronic device after the attitude is changed.

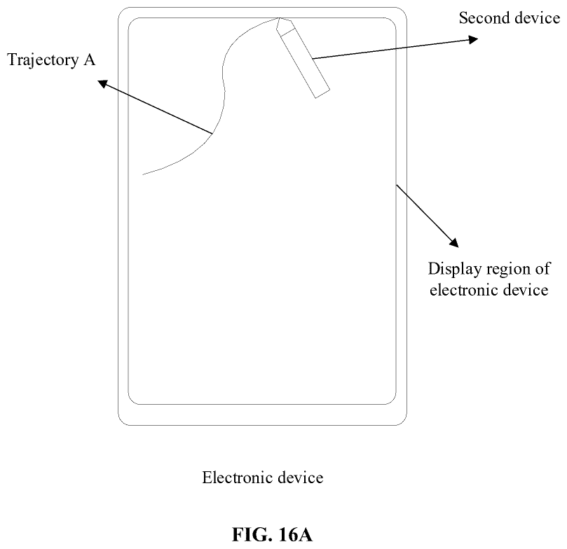

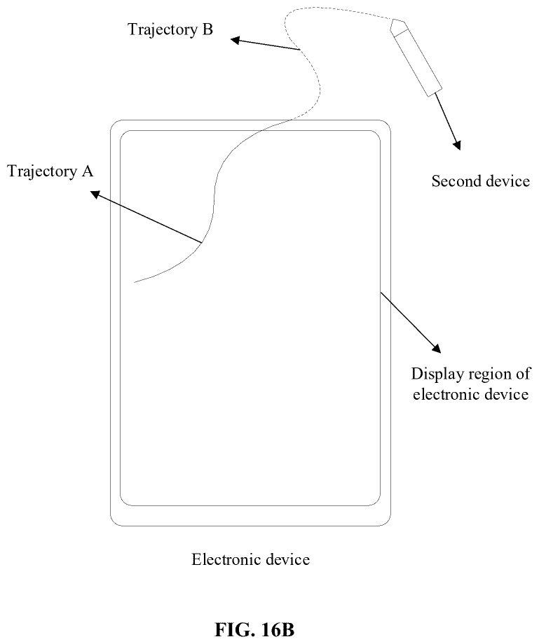

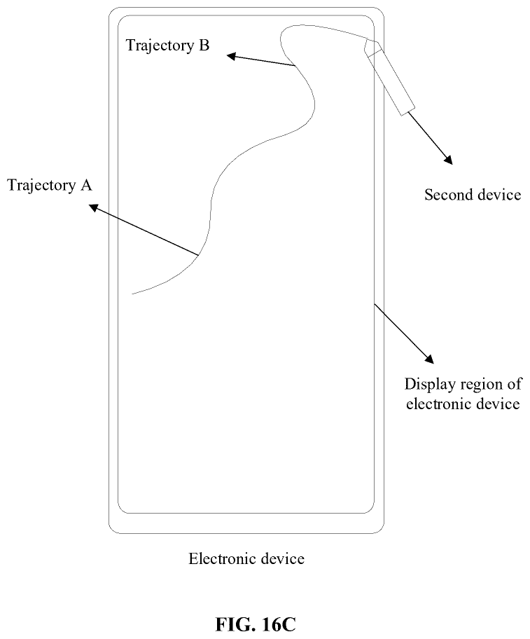

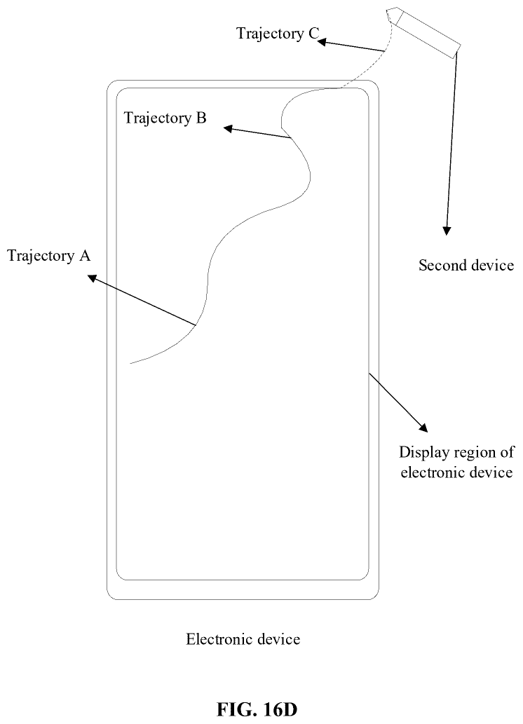

For example, as shown in FIG. 16A, the second device may move in the display region of the electronic device and draw the trajectory A. After the target operation is completed, the target trajectory corresponding to the trajectory A may be synchronously displayed in the display region of the electronic device.

At 502, in response to that the target operation is being performed, the target trajectory corresponding to the first trajectory may be displayed in the display region that changes with the attitude of the electronic device. In response to that the target trajectory cannot be fully displayed, the target trajectory may be stored. The target trajectory may be the mapping trajectory of the first trajectory on same horizontal plane of the output apparatus of the electronic device.

For example, as shown in FIG. 16B, the second device may move in the display region of the electronic device; and after drawing trajectory A, the second device may continue to move and draw the trajectory B. The target operation may be to expand the screen of the electronic device. Therefore, as shown in FIG. 16C, the target trajectory corresponding to the trajectory may be displayed in the expanding display region of the electronic device. As shown in FIG. 16D, in response to that the electronic device has expanded to the maximum and cannot expand further, and the second device may continue to move and draw the trajectory C. The trajectory C may exceed the display region of the electronic device, such that the trajectory C may be stored.

It should be noted that the target trajectory may be the mapping trajectory of the first trajectory on same horizontal plane of the output apparatus of the electronic device. In response to the height of the second device changes, it may indicate that the first trajectory has been drawn.

In above-mentioned solution, by obtaining the first trajectory drawn by the second device on same horizontal plane as the output apparatus of the electronic device, corresponding target trajectory may be determined and synchronously displayed in the display region of the electronic device, and the target trajectory may be synchronously displayed in the display region added after the screen of the electronic device is expanded, thereby improving the usability of the electronic device. By storing the trajectory that exceeds the display region of the electronic device after the electronic device expands to the maximum, when the screen is not large enough to meet the user's drawing needs, the content drawn by the user after leaving the screen of the electronic device under set circumstances may be saved for the user to process subsequently, thereby further improving the user experience.

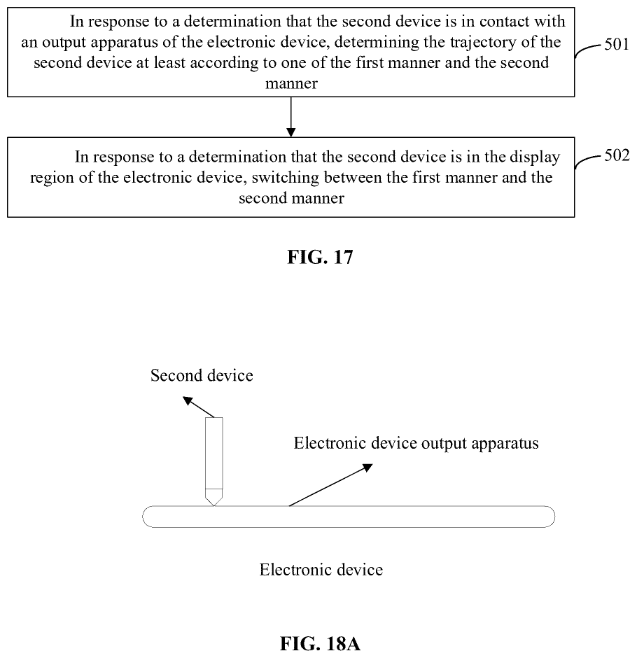

An electronic device control method is also provided in one embodiment of the present disclosure. As shown in FIG. 17, the control method may at least further include one of the following exemplary steps.

At 601, in response to determination that the second device is in contact with the output apparatus of the electronic device, the trajectory may be determined using at least one of the first manner and the second manner.

Whether the second device is in contact with the output apparatus of the electronic device may be determined by whether the screen of the electronic device receives the touch screen signal. In response to determination that the second device is in contact with the output apparatus of the electronic device, the trajectory of the second device may be determined by the spatial position of the second device; or the trajectory of the second device may be determined by the touch screen signal of the second device on the electronic device.

For example, in response to determination that after the second device is in contact with the output apparatus of the electronic device, the second device moves to the edge of the output apparatus and continues to move outside the edge of the electronic device, the trajectory of the second device may be determined by combining the touch screen signal of the second device on the electronic device and the spatial position of the second device. The trajectory of the second device may also be determined entirely by the spatial position of the second device.

At 602, in response to determination that the second device is in the display region of the electronic device, the first manner and the second manner may be switched.

In response to determination that the second device is in the display region of the electronic device, the second device may be in contact with the output apparatus of the electronic device.

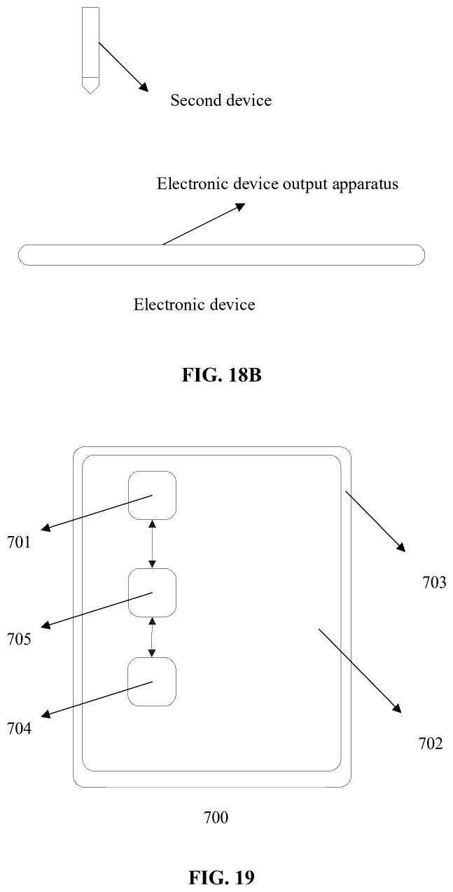

For example, as shown in FIG. 18A, the second device may be in the display region of the electronic device, and the second device may be in contact with the output apparatus of the electronic device. At this point, the trajectory of the second device may be determined by the touch screen signal generated by the contact between the second device and the output apparatus of the electronic device.

For another example, as shown in FIG. 18B, the second device may be in the display region of the electronic device, but the second device may not be in contact with the output apparatus of the electronic device. At this point, the trajectory of the second device may be determined by the spatial position of the second device.

An electronic device is provided in embodiments of the present disclosure. FIG. 19 illustrates a schematic block diagram of an exemplary electronic device 700 that may be configured to implement embodiments of the present disclosure. The electronic device may be intended to represent various forms of digital computers, such as laptop computers, desktop computers, workstations, personal digital assistants, servers, blade servers, mainframe computers, and other suitable computers. The electronic device may also represent various forms of mobile devices, such as personal digital assistants, cellular phones, smart phones, wearable devices, and other similar computing devices. The components, and connections, relationships and functions thereof may be merely exemplary and may be not intended to limit the implementation of the present disclosure described and/or required herein.

As shown in FIG. 19, the electronic device 700 may include a signal obtaining module 701 configured to obtain the position information of the second device; a deformable display apparatus 702, where the region of the display apparatus for display output may include a deformable region, the deformable region may include the first orientation and the second orientation which are different from each other, the display apparatus may switch between the first attitude and the second attitude, and the area of the deformable region may change relative to the region for display output; a housing 703; a power apparatus 704 configured to drive the display apparatus to move relative to the housing; and a processor 705 configured to determine whether the second device is in the target region based on the position information of the second device, and determine the target operation at least based on the position information in response to determination that the second device is in the target region. The power apparatus may be controlled to drive the display apparatus to perform the target operation, and the target operation may be configured to control the electronic device to change attitude.

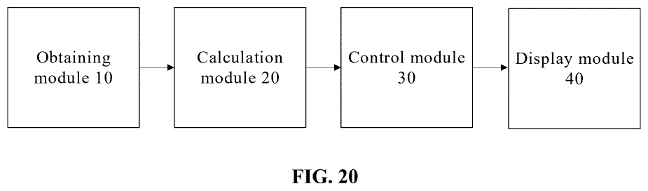

In order to implement above-mentioned electronic device control method, as shown in FIG. 20, an electronic device control apparatus is provided in embodiments of the present disclosure. The electronic device control apparatus may include an obtaining module 10 configured to determine whether the second device is in the target region based on the position information of the second device; a calculation module 20 configured to determine the target operation at least based on the position information in response to determination that the second device is in the target region; and a control module 30 configured to perform the target operation, where the target operation may be configured to control the electronic device to change attitude.

The calculation module 20 may be further configured to, based on the position information of the second device, determine the first trajectory of the second device in the target region. The first trajectory may be determined according to the first manner. The first trajectory may be the spatial trajectory of the second device.

The calculation module 20 may be further configured to, based on the position information of the second device, determine the second trajectory of the second device in the target region. The second trajectory may be determined according to the second manner. The second trajectory may be the trajectory of the second device being in contact with the electronic device and moving relative to the electronic device. The first manner may be different from the second manner.

The calculation module 20 may be further configured to determine the target operation based on the position information in response to a satisfaction of at least one of following conditions.

The calculation module 20 may be further configured to determine that the first trajectory is the preset trajectory; and

The calculation module 20 may be further configured to determine that the second trajectory is the preset trajectory.

The calculation module 20 may be further configured to determine that the determination result may characterize the second device to be in the target region in response to determination that the second device is at least in the first region based on the position information. The first region may not include the display region of the electronic device.

The calculation module 20 may be further configured to determine that the determination result may characterize the second device to be in the target region in response to determination that the second device is at least in the display region of the electronic device based on the position information.

The calculation module 20 may be further configured to determine the target position based on the determination result. The determination result may be whether the second device is in the target region.

The control module 30 may be further configured to control the electronic device to change attitude, such that the edge of the display region of the electronic device may be adjusted to the target position, where the position information may at least include the movement direction of the second device, and the adjustment direction of the edge may be related to the movement direction of the second device.

The control module 30 may be further configured to control the electronic device to change attitude in response to determination that the electronic device is in the first state, such that the edge of the display region of the electronic device may be adjusted to the target position. The first state may characterize that the output apparatus of the electronic device may perform the first operation.

The control module 30 may be further configured to control the electronic device to change attitude in response to determination that the electronic device is in the second state, such that the edge of the display region of the electronic device may be adjusted to the target position. The second state may characterize that the output apparatus of the electronic device may perform the second operation. The first operation may be different from the second operation. The display region after performing the first operation may be greater than the display region before performing the first operation; and the display region after performing the second operation may be smaller than the display region before performing the second operation.

The electronic device control apparatus may further include a display module 40. The display module 40 may be configured to, after the target operation is completed, display the target trajectory corresponding to the first trajectory in the display region of the electronic device after the attitude is changed.

The display module 40 may be further configured, in response to that the target operation is being performed, to display the target trajectory corresponding to the first trajectory in the display region that changes with the attitude of the electronic device. In response to that the target trajectory cannot be fully displayed, the target trajectory may be stored. The target trajectory may be the mapping trajectory of the first trajectory on same horizontal plane of the output apparatus of the electronic device.

The calculation module 20 may be further configured to, in response to determination that the second device is in contact with the output apparatus of the electronic device, determine the trajectory using at least one of the first manner and the second manner.

The calculation module 20 may be further configured to, in response to determination that the second device is in the display region of the electronic device, switch between the first manner and the second manner.

Various embodiments of the systems and techniques described in the present disclosure may be implemented in digital electronic circuit systems, integrated circuit systems, field programmable gate arrays (FPGAs), application specific integrated circuits (ASICs), application specific standard products (ASSPs), integrated systems on chips (SOCs), complex programmable logic devices (CPLDs), computer hardware, firmware, software, and/or combinations thereof. Above various embodiments may include being implemented in one or more computer programs that may be executed and/or interpreted on a programmable system which may include at least one programmable processor. The programmable processor may be a dedicated or general programmable processor, which may receive data and instructions from a storage system, at least one input apparatus, and at least one output apparatus; and transmit data and instructions to the storage system, the at least one input apparatus, and the at least one output apparatus.

The program code for implementing the method of the present disclosure may be written in any combination of one or more programming languages. Above program code may be provided to a processor or controller of a general-purpose computer, a special-purpose computer, or other programmable data processing device, such that when the program code is executed by the processor or controller, the functions/operations specified in the flowchart and/or block diagram may be implemented. The program code may be executed entirely on the machine, partially on the machine, partially on the machine as a stand-alone software package and partially on a remote machine, or entirely on a remote machine or server.

In the context of the present disclosure, a machine-readable medium may be a tangible medium containing or storing programs used by an instruction execution system, an apparatus, a device, or a combination thereof. A machine-readable medium may be a machine-readable signal medium or a machine-readable storage medium. A machine-readable medium may include, but may be not limited to, an electronic, magnetic, optical, electromagnetic, infrared, or semiconductor system, apparatus, device, or any suitable combination thereof. Moreover, the machine-readable storage media may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combinations thereof.

To provide interaction with the user, the systems and techniques described in the present disclosure may be implemented on a computer. The computer may include a display apparatus (e.g., a CRT (cathode ray tube) or LCD (liquid crystal display) monitor) for displaying information to the user; and a keyboard and a pointing device (e.g., a mouse or track ball) through which the user may provide input to the computer. Other types of apparatuses may also be configured to provide interaction with the user. For example, the feedback provided to the user may be any form of sensory feedback (e.g., visual feedback, auditory feedback, or tactile feedback); and the input from the user may be received in any form (including acoustic input, voice input, or tactile input).

The systems and techniques described in the present disclosure may be implemented in a computing system including a backend component (e.g., as a data server), or a computing system including a middleware component (e.g., an application server), or a computing system including a frontend component (e.g., a user computer with a graphical user interface or a web browser through which the user may interact with implementation manners of the systems and techniques described in the present disclosure), or a computing system including any combination of backend components, middleware components, or frontend components. The components of the system may be interconnected by any form or medium of digital data communication (e.g., a communication network). Examples of communication networks may include a local region network (LAN), a wide region network (WAN), and the Internet.

The computer system may include a client and a server. The client and the server may be remote from each other and interact through a communication network. The relationship between the client and the server may be generated by computer programs running on corresponding computers and having a client-server relationship with each other. The server may be a cloud server, a server of a distributed system, or a server combined with a blockchain.

Various embodiments of the present disclosure further provide a non-transitory computer-readable storage medium, containing a computer program for when executed by a processor, performing an electronic device control method. The method includes determining whether a second device is in a target region based on position information of the second device; in response to a determination that the second device is in the target region, determining a target operation at least based on the position information of the second device; and executing the target operation, wherein the target operation is configured to control an electronic device to change attitude.

It should be understood that various forms of processes shown above may be configured to reorder, add or delete exemplary steps. For example, exemplary steps recorded in the present disclosure may be executed in parallel, sequentially or in different orders, as long as desired results of the technical solution disclosed in the present disclosure are achieved, which may not be limited in the present disclosure.

In addition, the terms “first” and “second” may be used only for descriptive purposes and cannot be understood as indicating or implying relative importance or implicitly indicating the number of technical features indicated. Therefore, the features defined as “first” and “second” may explicitly or implicitly include at least one of the features. In the description of the present disclosure, the meaning of “plurality” may be two or more, unless otherwise clearly and specifically defined.

The above may merely be embodiments of the present disclosure, but the protection scope of the present disclosure may not be limited thereto. Those skilled in the art may easily think of changes or substitutions within the technical scope disclosed in the present disclosure, which should be covered by the protection scope of the present disclosure. Therefore, the protection scope of the present disclosure should be subject to the protection scope of the claims.

What is claimed is

1. An electronic device control method, comprising:
determining whether a second device is in a target region based on position information of the second device;
in response to a determination that the second device is in the target region, determining a target operation at least based on the position information of the second device; and
executing the target operation, wherein the target operation is configured to control an electronic device to change attitude.

2. The method according to claim 1, further including:
determining a first trajectory of the second device in the target region based on the position information of the second device, wherein the first trajectory is a spatial trajectory of the second device and determined according to a first manner;
determining a second trajectory of the second device in the target region based on the position information of the second device, wherein the second trajectory is determined according to a second manner; the second trajectory is a trajectory of the second device being in contact with and moving relative to the electronic device; and the first manner is different from the second manner; and
determining the target operation based on the position information of the second device in response to a satisfaction of at least one of following conditions that include a determination that the first trajectory is a preset trajectory and a determination that the second trajectory is a preset trajectory.

3. The method according to claim 1, wherein determining whether the second device is in the target region based on the position information of the second device includes:
in response to a determination that the second device is at least in a first region based on the position information of the second device, determining that a determination result characterizes the second device to be in the target region, wherein the first region does not include a display region of the electronic device.

4. The method according to claim 1, wherein determining whether the second device is in the target region based on the position information of the second device includes:
in response to a determination that the second device is at least in a display region of the electronic device based on the position information of the second device, determining that a determination result characterizes the second device to be in the target region.

5. The method according to claim 1, wherein executing the target operation includes:
determining a target position based on a determination result, wherein the determination result is whether the second device is in the target region; and
controlling the electronic device to change attitude, such that an edge of a display region of the electronic device is adjusted to the target position, wherein the position information of the second device at least includes a movement direction of the second device, and an adjustment direction of the edge is associated with the movement direction of the second device.

6. The method according to claim 5, further including:
in response to a determination that the electronic device is in a first state, controlling the electronic device to change attitude, such that the edge of the display region of the electronic device is adjusted to the target position, wherein the first state characterizes that an output apparatus of the electronic device is capable of executing a first operation; and
in response to a determination that the electronic device is in a second state, controlling the electronic device to change attitude, such that the edge of the display region of the electronic device is adjusted to the target position, wherein the second state characterizes that the output apparatus of the electronic device is capable of executing a second operation; the first operation is different from the second operation; the display region after the first operation is executed is greater than the display region before the first operation is executed; and the display region after the second operation is executed is less than the display region before the second operation is executed.

7. The method according to claim 2, further including at least one of following:
after execution of the target operation is completed, displaying a target trajectory corresponding to the first trajectory in the display region of the electronic device after the attitude is changed; and
in response to that the target operation is being executed, displaying a target trajectory corresponding to the first trajectory in the display region that changes with the attitude of the electronic device, wherein in response to that the target trajectory is not fully displayed, the target trajectory is stored, and the target trajectory is a mapping trajectory of the first trajectory on a same horizontal plane of an output apparatus of the electronic device.

8. The method according to claim 2, further including at least one of following:
in response to a determination that the second device is in contact with an output apparatus of the electronic device, determining the trajectory of the second device at least according to one of the first manner and the second manner; and
in response to a determination that the second device is in the display region of the electronic device, switching between the first manner and the second manner.

9. An electronic device, comprising:
a signal obtaining module, configured to obtain position information of a second device;
a deformable display apparatus, wherein a region of the deformable display apparatus for display output includes a deformable region; the deformable region has a first orientation and a second orientation; the first orientation is different from the second orientation; the deformable display apparatus switches between a first attitude and a second attitude; and an area of the deformable region is capable of being changed relative to the region of the deformable display apparatus for display output;
a housing;
a power apparatus, configured to drive the display apparatus to move relative to the housing; and
a processor, configured to determine whether the second device is in a target region based on the position information of the second device; in response to a determination that the second device is in the target region, determine a target operation at least based on the position information of the second device; and control the power apparatus to drive the display apparatus to execute the target operation, wherein the target operation is configured to control the electronic device to change attitude.

10. The electronic device according to claim 9, wherein the processor is further configured to:
determine a first trajectory of the second device in the target region based on the position information of the second device, wherein the first trajectory is a spatial trajectory of the second device and determined according to a first manner;
determine a second trajectory of the second device in the target region based on the position information of the second device, wherein the second trajectory is determined according to a second manner; the second trajectory is a trajectory of the second device being in contact with and moving relative to the electronic device; the first manner is different from the second manner; and
determine the target operation based on the position information of the second device in response to a satisfaction of at least one of following conditions that include a determination that the first trajectory is a preset trajectory and a determination that the second trajectory is a preset trajectory.

11. The electronic device according to claim 9, wherein for determining whether the second device is in the target region based on the position information of the second device, the processor is configured to:
in response to a determination that the second device is at least in a first region based on the position information of the second device, determine that a determination result characterizes the second device to be in the target region, wherein the first region does not include a display region of the electronic device.

12. The electronic device according to claim 9, wherein for determining whether the second device is in the target region based on the position information of the second device, the processor is configured to:
in response to a determination that the second device is at least in a display region of the electronic device based on the position information of the second device, determine that a determination result characterizes the second device to be in the target region.

13. The electronic device according to claim 9, wherein for executing the target operation, the processor is configured to:
determine a target position based on a determination result, wherein the determination result is whether the second device is in the target region; and
control the electronic device to change attitude, such that an edge of a display region of the electronic device is adjusted to the target position, wherein the position information of the second device at least includes a movement direction of the second device, and an adjustment direction of the edge is associated with the movement direction of the second device.

14. The electronic device according to claim 13, wherein the processor is further configured to:
in response to a determination that the electronic device is in a first state, control the electronic device to change attitude, such that the edge of the display region of the electronic device is adjusted to the target position, wherein the first state characterizes that an output apparatus of the electronic device is capable of executing a first operation; and
in response to a determination that the electronic device is in a second state, control the electronic device to change attitude, such that the edge of the display region of the electronic device is adjusted to the target position, wherein the second state characterizes that the output apparatus of the electronic device is capable of executing a second operation; the first operation is different from the second operation; the display region after the first operation is executed is greater than the display region before the first operation is executed; and the display region after the second operation is executed is less than the display region before the second operation is executed.

15. The electronic device according to claim 10, wherein the processor is further configured to perform at least one of following:
after execution of the target operation is completed, displaying a target trajectory corresponding to the first trajectory in the display region of the electronic device after the attitude is changed; and
in response to that the target operation is being executed, displaying a target trajectory corresponding to the first trajectory in the display region that changes with the attitude of the electronic device, wherein in response to that the target trajectory is not fully displayed, the target trajectory is stored, and the target trajectory is a mapping trajectory of the first trajectory on a same horizontal plane of an output apparatus of the electronic device.

16. The electronic device according to claim 10, wherein the processor is further configured to perform at least one of following:
in response to a determination that the second device is in contact with an output apparatus of the electronic device, determining the trajectory of the second device at least according to one of the first manner and the second manner; and
in response to a determination that the second device is in the display region of the electronic device, switching between the first manner and the second manner.

17. A non-transitory computer-readable storage medium, containing a computer program for when executed by a processor, performing an electronic device control method, the method comprising:
determining whether a second device is in a target region based on position information of the second device;
in response to a determination that the second device is in the target region, determining a target operation at least based on the position information of the second device; and
executing the target operation, wherein the target operation is configured to control an electronic device to change attitude.

18. The storage medium according to claim 17, wherein the processor is further configured to:
determine a first trajectory of the second device in the target region based on the position information of the second device, wherein the first trajectory is a spatial trajectory of the second device and determined according to a first manner;
determine a second trajectory of the second device in the target region based on the position information of the second device, wherein the second trajectory is determined according to a second manner; the second trajectory is a trajectory of the second device being in contact with and moving relative to the electronic device; the first manner is different from the second manner; and
determine the target operation based on the position information of the second device in response to a satisfaction of at least one of following conditions that include a determination that the first trajectory is a preset trajectory and a determination that the second trajectory is a preset trajectory.

19. The storage medium according to claim 17, wherein for determining whether the second device is in the target region based on the position information of the second device, the processor is configured to:
in response to a determination that the second device is at least in a first region based on the position information of the second device, determine that a determination result characterizes the second device to be in the target region, wherein the first region does not include a display region of the electronic device.

20. The storage medium according to claim 17, wherein for determining whether the second device is in the target region based on the position information of the second device, the processor is configured to:
in response to a determination that the second device is at least in a display region of the electronic device based on the position information of the second device, determine that a determination result characterizes the second device to be in the target region.
